(19) United States
(12) Patent Application Publication
(10) Pub. No.: US 2013/0238181 A1
(43) Pub. Date: Sep. 12, 2013

(54) ON-BOARD VEHICLE PATH PREDICTION USING PROCESSED SENSOR INFORMATION

(71) Applicant: Michael Robert JAMES, Northville, MI (US)

(72) Inventor: Michael Robert JAMES, Northville, MI (US)

(73) Assignee: TOYOTA MOTOR ENG. & MAN. NORTH AMERICA (TEMA), Erlanger, KY (US)

(21) Appl. No.: 13/417,999

(22) Filed: Mar. 12, 2012

(51) Int. Cl. G06F 17/00; G05D 1/00

(52) U.S. Cl. 701/23; 701/300

(57) ABSTRACT

A driven vehicle receives position data of a subject vehicle nearby the driven vehicle, and associates the position data of the subject vehicle with a driving model. The driving model is updated by incorporating latest position data of the subject vehicle, and a future position of the subject vehicle is predicted using the updated driving model. The predicted future position of the subject vehicle can be transmitted to other processing systems of the driven vehicle, including a collision avoidance or warning system, which provides a driver notification, and an autonomous driving system, which provides vehicle actuation. A determination is made as to whether the position data of the subject vehicle fits a currently stored and available driving model, and generates a new driving model no model fits. The new model is a multi-mode predictive state representation (MMPSR) which marginalizes unknown modes of history.

### BACKGROUND

This disclosure relates to modeling multiple-mode systems with predictive state representations.

There are various techniques available for vehicle and target tracking. Further, it is known to use a multi-modal approach based on vehicular maneuvers to predict a path for a vehicle.

### SUMMARY

None of the known techniques describe multi-modal aspects of multi-mode predictive state representations (MMPSRs) based on modes that can be defined in terms of past and future observations to allow modes to be recognized from a window of both past and future observations. A multi-modal driving model is incorporated with on-vehicle sensor processing capabilities to generate predictions of nearby vehicles. Sensor data representative of positions of nearby vehicles is used and passed to a prediction module. The prediction module processes the data and makes predictions for possible vehicle paths. The results from these predictions can then be passed on to other related systems such as safety warning, driver assistance, and autonomous driving systems.

An MMPSR is developed from learning high and low-level component models from a single sequence of observations, and is updated in time-steps to reflect new history. The MMPSR is used to make predictions about next observations based on a history of observations to marginalize unknown modes of history. Positions of nearby vehicles are identified and passed to a prediction module. The prediction module uses a learned multi-modal model of vehicle behavior for each detected vehicle, where the model may be an existing model or newly created. Location or position data is used to update the model for a vehicle, which is in turn used to make predictions about future positions of the vehicle. These future predictions of the position of the vehicle can then be used for predicting collisions or other vehicle safety, driver assistance or autonomous driving systems.

The foregoing general description and the following detailed description are exemplary, not restrictive, embodiments.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram of the component models in an MMPSR;

FIG. 2 is a diagram of how mode variables relate to observations;

FIG. 3 is a diagram illustrating a situation in a traffic system where multiple possible further paths are predicted by the prediction module;

FIG. 4 is a diagram illustrating predictions made by component models;

FIG. 5 is a diagram of a Markov chain used to generate modes for a random walk system;

FIG. 6 is a chart of predicted probability of a current generative mode in a random walk system with an MMPSR;

FIG. 7 shows charts of mean errors of an MMPSR and comparison models;

FIG. 8 is a table of error in predicting distance traveled for simulated traffic;

FIG. 9 is a table of predicting a current mode for simulated traffic;

FIG. 10 is a chart of predicting a current mode for I-80 traffic;

FIG. 11 is a table of error in predicting distance traveled for I-80 traffic;

FIG. 12 is a table of error in predicting lateral movement for I-80 traffic;

FIG. 13 is a functional block diagram of a vehicle path prediction system;

FIG. 14 is a hardware diagram of a processing system embodying the vehicle path prediction system shown in FIG. 13;

FIG. 15 is an algorithmic flowchart illustrating a positioning procedure of the vehicle path prediction system shown in FIG. 13; and

FIG. 16 is an algorithmic flowchart illustrating a prediction procedure of the vehicle path prediction system shown in FIG. 13.

### DETAILED DESCRIPTION OF THE EMBODIMENTS

Reference will now be made to the drawings, wherein like reference numerals designate identical or corresponding parts throughout the several views.

Predictive state representations (PSRs) are a class of models that represent the state of a dynamical system as a set of predictions about future events. This work introduces a class of structured PSR models called multi-mode PSRs (MMPSRs), which were inspired by the problem of modeling traffic. In general, MMPSRs can model uncontrolled dynamical systems that switch between several modes of operation. An important aspect of the model is that the modes must be recognizable from a window of past and future observations. Allowing modes to depend upon future observations means the MMPSR can model systems where the mode cannot be determined from only the past observations. Requiring modes to be defined in terms of observations makes the MMPSR different from hierarchical latent-variable based models.

This difference is significant for learning the MMPSR, because there is no need for costly estimation of the modes in the training data: their true values are known from the mode definitions. Furthermore, the MMPSR exploits the modes' recognizability by adjusting its state values to reflect the true modes of the past as they become revealed. The empirical evaluation of the MMPSR, as presented below, shows that the accuracy of a learned MMPSR model compares favorably with other learned models in predicting both simulated and real-world highway traffic.

Multi-Mode PSRS (MMPSRS)

Predictive state representations (PSRs) are a class of models that represent the state of a dynamical system as a set of predictions about future events. PSRs are capable of representing partially observable, stochastic dynamical systems, including any system that can be modeled by a finite partially observable Markov decision process (POMDP).

There is evidence a predictive state is useful for generalization and helps to learn more accurate models than the state representation of a POMDP. This work introduces a class of structured hierarchical PSR models called multimode PSRs (MMPSRs) for modeling uncontrolled dynamical systems that switch between several modes of operation.

Unlike latent-variable models like hierarchical HMMs, the MMPSR requires that the modes be a function of past and future observations. This requirement yields advantages both when learning and using an MMPSR, as explained below.

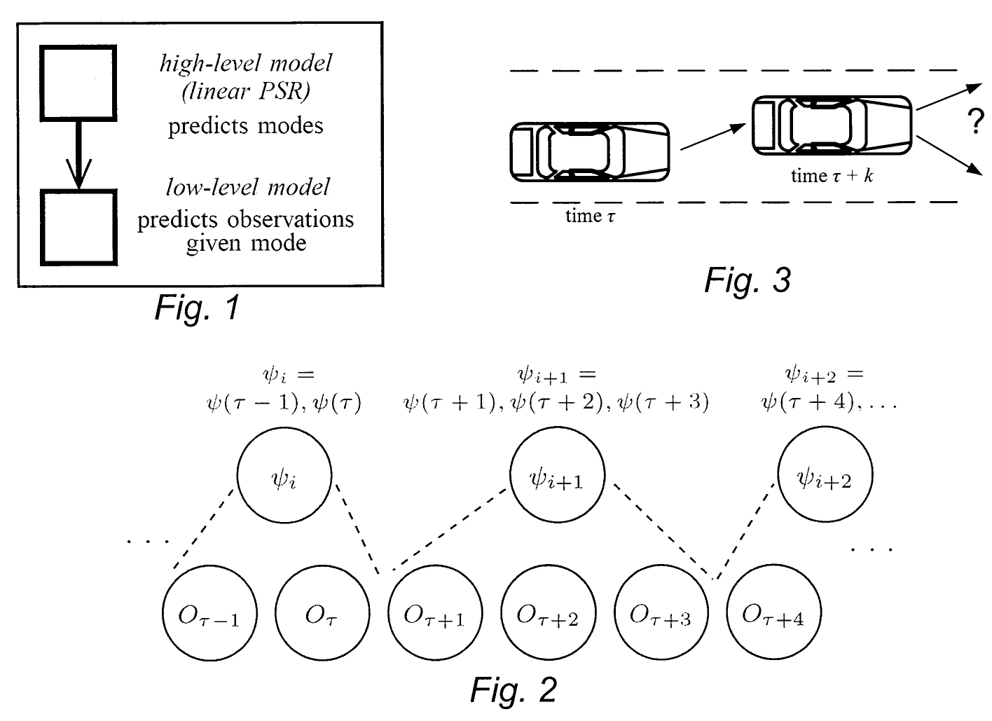

The MMPSR is inspired by the problem of predicting a cars' movements on a highway. One way to predict the car's movements would be to determine what mode of behavior the car was in (e.g., a left lane change, right lane change, or going straight) and make predictions about the car's movement conditioned upon that mode of behavior. The MMPSR makes predictions in this way using two component models which form a simple, two-level hierarchy as shown in FIG. 1. FIG. 1 shows the component models in an MMPSR.

When modeling highway traffic, the high-level model will predict the mode of behavior, and the low-level model will make predictions about the car's future positions conditioned upon the mode of behavior. The following discussion relates to formalizing the MMPSR model in general terms, and making it applicable to dynamical systems other than highway traffic.

Observations and Modes

The MMPSR can model uncontrolled, discrete-time dynamical systems, where the agent receives some observation Oᵢ at each time step i=1, 2, . . . . The observations can be vector-valued and can be discrete or continuous. In addition to the observations that the agent receives from the dynamical system, the MMPSR requires that there exists a discrete set of modes the system could be in, and that there is some mode associated with each time step. The system can be in the same mode for several time steps, so a single mode can be associated with multiple contiguous time steps. The i^{th} mode since the beginning of time will be denoted by ψᵢ, and ψ(τ) will denote the mode for the τ time step. See FIG. 2, which shows how mode variables relate to observations. The observation at time τ is O_{τ}; the i^{th} mode seen since the beginning of time is ψᵢ; and ψ(τ) is the mode at time τ.

What distinguishes MMPSR models from hierarchical latent-variable models (e.g., hierarchical HMMs) is the fact that the modes are not latent. Instead, they are defined in terms of past and possibly future observations. Specifically, the modes used by an MMPSR must satisfy the following recognizability requirement: there is some finite k such that, for any sequence of observations O₁, . . . , O_{τ}, O_{τ+1}, . . . O_{τ+k} (for any τ≧0), the modes ψ(1), . . . , ψ(τ−1), ψ(τ) are known at time τ+k (or before). We say that a mode ψ(τ) is known at time τ′ (where τ′ can be greater than τ) if the definitions of the modes and the observations O₁, . . . , O_{τ′} from the beginning of time through time τ′ unambiguously determine the value of ψ(τ).

To reiterate, the recognizability requirement differentiates the MMPSR from hierarchical latent-variable models. If one were to incorporate the fact that modes were recognizable into a hierarchical latent-variable model, one would in effect get an MMPSR. The recognizability of the modes plays a crucial role in learning an MMPSR, because the modes for the batch of training data are known. If the modes were not recognizable, then one would have to use the expectation-maximization algorithm to estimate the latent modes, as is typical in hierarchical latent-variable models. The MMPSR also exploits the recognizability of the modes when maintaining its state, as described below.

Because the modes can be defined in terms of past and future observations, the MMPSR is not limited to using history-based modes. A model using history-based modes would only apply to systems where the current mode ψ(τ) was always known at time τ. In contrast, the MMPSR can model systems where the agent will not generally know the mode ψ(τ) until several time steps after τ. The traffic system is an example system where there are natural modes (e.g. a “left lane change” mode) that can be defined in terms of past and future observations, but not past observations alone.

During the first few time steps of a left lane change, the mode at those times is not known from the past observations of the car (referring to FIG. 3): the car could be in the “going straight” mode but weaving in its lane, or it could be starting the “left lane change” mode. Even though the “left lane change” mode will not immediately be known, it can be recognized when the car crosses the lane boundary. Thus, the “left lane change” mode can be defined as “the car crossed a lane boundary from right to left within the most recent k time steps or it will do so within the next k time steps.”

FIG. 3 illustrates a situation in a traffic system where the mode for the last few time steps of history is unknown. After moving from the position on the left of the figure at time τ to the position towards the right at time τ+k, it is unclear if the car is beginning a left lane change or is just weaving in its lane. These two possibilities will assign different modes to the time steps τ through τ+k (i.e., “left lane change” vs. “going straight”).

Defining the modes in terms of future observations provides a common characteristic with other PSR models, where the state is defined in terms of future observations. The PSR literature shows that a handful of features of the short-term future can be very powerful, capturing information from arbitrarily far back in history. This motivates the MMPSR's use of modes that are defined in terms of past and future observations.

The recognizability requirement is a constraint on the definitions of the modes and not on the dynamical system itself. That is, requiring the modes to be recognizable does not limit the dynamical systems one can model with an MMPSR. Given any system, one can define a recognizable set of modes by simply ensuring that the modes partition the possible history/length-k-future pairs (for some finite k).

Then for any history and length-k future, exactly one mode definition is satisfied. Furthermore, the modes that are defined for use by the MMPSR do not need to match the modes that the system actually used to generate the data (although a closer match might improve the accuracy of the MMPSR). This flexibility permits mode definitions that are approximations of complicated concepts like lane changes. Discussed later are experiments where the mode definitions approximate the process used to generate the data.

In addition to the recognizability requirement, the MMPSR makes the following independence assumptions that characterize the relationship between modes and observations:

(1) The observation O_{τ+1} is conditionally independent of the history of modes given the mode at time τ+1 and the history of observations O₁, . . . , O_{τ}.

(2) The future modes ψᵢ₊₁, . . . are conditionally independent of the observations through the end of ψᵢ, given the history of modes ψ₁, . . . , ψᵢ.

Even if the independence properties do not strictly hold, the MMPSR forms a viable approximate model, as demonstrated by the empirical results described below.

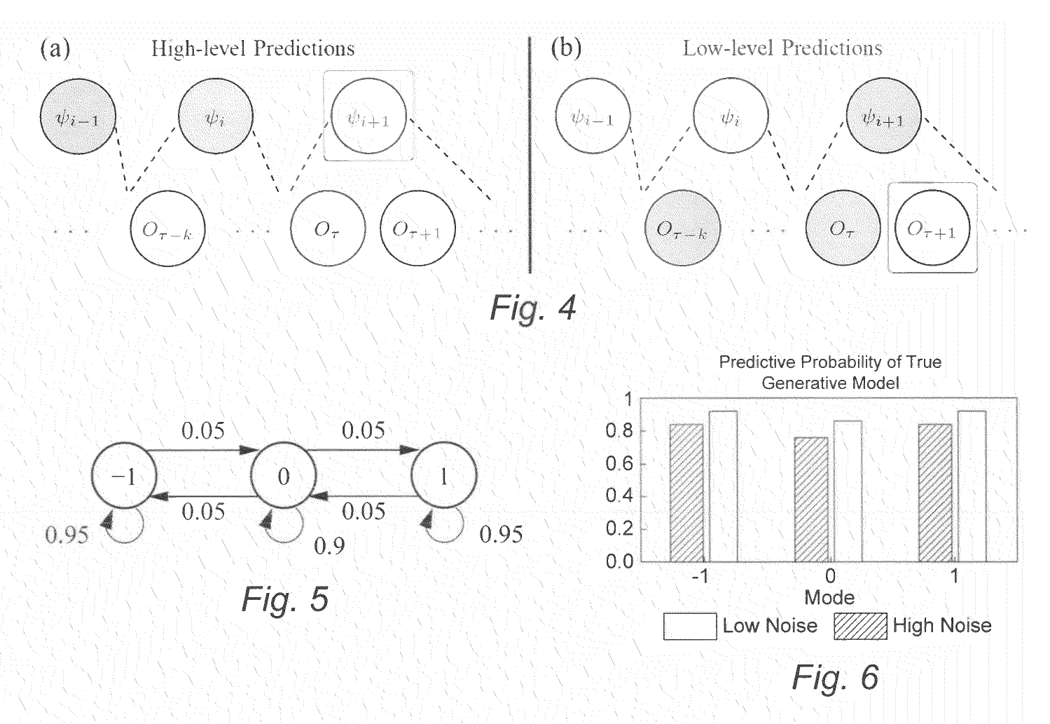

These independence properties lead to the forms of the high and low-level models within the MMPSR. The low-level model makes predictions for the next observation given the history of observations and the mode at the next time step. See FIG. 4, (b). The low-level model will also predict the probability of a mode ending at time τ, given ψ(τ) and the history of observations through time τ. The high-level model makes predictions for future modes given the history of modes. See FIG. 4, (a).

FIG. 4 illustrates predictions made by the component models. The subscripts for the modes differ from the observations because each mode will last for several time steps (so i<<τ). In (a), the high-level model predicts ψᵢ₊₁ given the history of modes (shaded). In (b), the low-level model predicts O_{τ+1} given the history of observations and current mode (shaded).

Because of the second independence assumption, the high-level model can be learned and used independently from the low-level model; it models the sequence of modes ψ₁, ψ₂, . . . while abstracting away details of the observations.

Updating the MMPSR State

The state of the MMPSR must be updated every time step to reflect the new history. Suppose for a moment that for all τ, ψ(τ) was known at time τ. Then the high-level model would update its state whenever a mode ends, using that mode's value as its “observation.” The low-level model would update its state after every time step τ, conditioned upon the most recent observation O_{τ} and the mode ψ(τ).

Even though ψ(τ) will not always be known at time τ, this process defines the states of the high and low-level models under the assumption that some hypothetical values ψ(1), . . . , ψ(τ) are the modes of history. Each sequence of hypothetical values has some posterior probability given the observations through time τ. The number of sequences ψ(1), . . . , ψ(τ) with non-zero posterior probability will remain bounded, even as τ→∞. Specifically, only one sequence of hypothetical values for the known modes will have non-zero posterior probability (i.e., the modes' true values), and only a finite (and typically small) window of past modes will be unknown, because of the recognizability requirement.

The MMPSR state at time τ consists of the posterior distribution over the modes of history and the high and low-level model states corresponding to each sequence ψ(1), . . . , ψ(τ) with non-zero posterior probability. At the next time step τ+1, the MMPSR updates its state as follows.

The MMPSR computes the high and low-level models' states for a given ψ(1), . . . , ψ(τ), ψ(τ+1) from the high and low-level models' states at time τ using the respective model updates. The MMPSR updates the posterior distribution over modes of history using Bayes' Rule.

Because the learned component models of an MMPSR will not be perfectly accurate, the Bayesian posterior update might not assign zero probability to hypothetical mode values even if they contradict the recognized value for those modes. Thus, in addition to the Bayesian posterior update, after each time step the MMPSR explicitly assigns zero probability to values of the history modes that contradict the known values, renormalizing the distribution after those changes. In addition, one can use pruning techniques (e.g. keep only the k most likely sequences of history modes) to reduce the number of history mode sequences that are maintained in the posterior distribution.

Making Predictions with an MMPSR

The MMPSR can make predictions about the next observation O_{τ+1} given the history of observations O₁, . . . , O_{τ}. Predictions of this form can be combined to make any prediction about the system, including predictions further than one step in the future. For a given assignment to the modes ψ(1), . . . , ψ(τ+1), the low-level model can directly predict O_{τ+1} given O₁, . . . , O_{τ}. Since not all of ψ(1), . . . , ψ(τ+1) will be known at time τ, the MMPSR makes predictions about O_{τ+1} given O₁, . . . , O_{τ} by marginalizing the modes that are not known. This marginalization can be done relatively efficiently by using the distribution over modes that the MMPSR maintains.

To make predictions about observations several time steps in the future, it can be more efficient to make those predictions directly rather than calculating them from several next-observation predictions. For example, in the empirical results, included in the MMPSR are several regression models to predict features of the future given the state of the low-level model and the most recent mode. As with the next-observation predictions, the overall prediction from the MMPSR marginalizes the unknown modes of history.

Learning an MMPSR

Learning an MMPSR consists of learning the high and low-level component models from a single sequence of observations (i.e. the training data). The high-level model is a linear PSR, so it is learned by applying the suffix-history algorithm to the sequence of modes of the training data. The recognizability of the modes ensures that the learning algorithm can correctly and automatically determine the mode for each time step of the training data (except a few time steps at the beginning and/or end of the data).

Learning the low-level model also requires the correct modes of the training data, since the low-level model makes predictions and updates its state conditioned upon the corresponding mode. One way to implement this conditional form is to have separate parameters of the low-level model for each mode. For example, the low-level model could consist of several parameterized functions from features of history (i.e., the state of the low-level model) to predictions about the next observation, with a separate function for each mode.

The function for each respective mode can then be learned by applying an appropriate regression method to the time steps of training data that have that mode. This form allows the low-level model to make specialized predictions for each mode. It is the form used in the following experiments.

Experiments

MMPSR models were learned for three systems: a simple random walk system, and both simulated and real-world highway traffic. The low-level model includes parameterized functions for each mode that map features from a finite window of history to predictions of interest.

Each function was learned using locally-weighted linear regression, a flexible non-linear function approximation method. The high-level linear PSR was learned using the suffix-history algorithm. Because the modes are defined in terms of observations, the modes of the training data are known, which is critical in ensuring efficient training of the model. If the modes were not known, then an iterative estimation procedure would be needed to estimate the modes (e.g. expectation-maximization), often requiring several iterations to converge. At each iteration, the estimated modes would change, so the low-level model would have to be re-learned.

In contrast, the low-level model of the MMPSR is only learned one time, using the true values of the modes because the modes are recognizable. For purposes of comparison, it would be possible to adapt hierarchical HMMs to exploit these modes, but as discussed above this would effectively yield an MMPSR. The comparison would then become a comparison between the suffix-history learning algorithm and the expectation-maximization learning algorithm, a comparison which has already been done with results showing the suffix-history algorithm to be generally superior. Therefore, hierarchical HMMs are not evaluated herein.

Random Walk

The empirical evaluation of the MMPSR begins with a simple random walk system, where the (scalar) observation at each time step is the change in (one-dimensional) position from the last time step. That change is given by the mode (which can take on values −1, 0, and 1) plus mean-zero Gaussian noise. The mode is determined by a Markov chain, an example of which is shown in FIG. 5. FIG. 5 shows the Markov chain used to generate the modes for the random walk system. The low-level model state consists of the average observations over the last k time steps for k ∈ {2, 5, 10}, along with a constant 1.0.

Because of the noise, the modes used to generate the data (called the generative modes) cannot be defined in terms of observations. Nevertheless, one can still define a set of recognizable modes in terms of observations. For the random walk system, the recognizable mode for time step τ is defined as the mode (−1, 0, or 1) that is closest to the average observation over five time steps, from τ−2 through τ+2. It should be appreciated this mode definition includes both historical and future observations.

While there will not be perfect correspondence between the recognizable modes and the generative modes, there is enough correlation that an MMPSR learned using the recognizable modes models the system well. FIG. 6 shows the average likelihood that the MMPSR assigns (from its distribution over modes of history) to each recognizable mode whenever its related generative mode was the (latent) system mode at that time step. The high and low noise results correspond to using Gaussian noise with standard deviations 0.5 and 0.25, respectively. Though the higher noise leads to less certainty about the mode, the MMPSR attributes high probability to the generative modes for both noise levels.

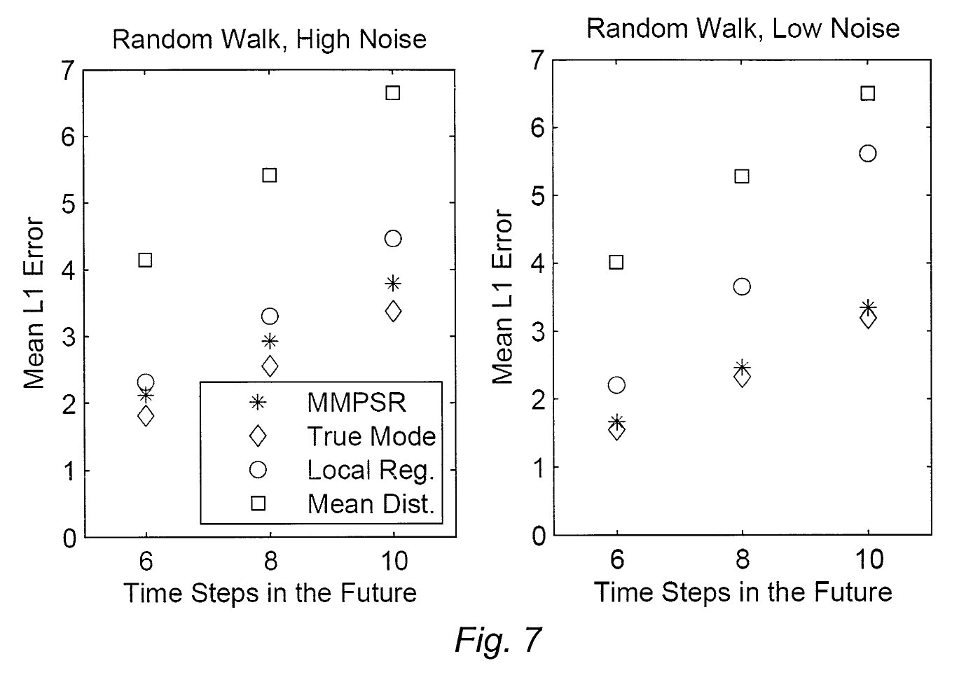

In addition to tracking the modes well, the MMPSR is also able to predict the future observations well. The average error for predicting several time steps in the future is shown in FIG. 7 for the high and low-noise systems. FIG. 7 shows prediction error of the MMPSR and comparison models. To give a qualitative sense of the error, “Mean Dist.” is the average distance traversed by the random walk. “True Mode” is the error when the MMPSR can artificially peer into the future to recognize the current mode. “Local Reg.” uses locally-weighted linear regression over the entire data set.

The MMPSR consistently achieves lower error than using locally-weighted linear regression on the entire data set, which does not explicitly leverage the existence of modes. For another comparison, an additional set of experiments were run where the MMPSR was artificially allowed to peer into the future and determine the value of the current mode (even though the current mode is not generally recognizable from the observations through the current time). The real MMPSR (which does not peer into the future) does almost as well as the artificial MMPSR that can peer into the future, especially in the low-noise system. See FIG. 7.

Traffic

MMPSRs were also learned to model simulated and real-world highway traffic. The MMPSR predicts the movements of a car given the history of that car and some neighboring cars. The observation at each time step consists of the x velocity, y velocity, and headway for the car being modeled, where headway is the time to collision with the car in front. As used herein, “x” refers to the lateral or side-to-side direction, and “y” refers to the longitudinal or forward direction. The features of history that composed the state of the low-level model were as follows: average y velocity over three different windows (the most recent 0.5 seconds, the 0.5 seconds before that, and the most recent 5 seconds); average x velocity over the most recent 0.5 seconds, and the 0.5 seconds before that; the x position; the distance to the closest car in front, and its average y velocity over the last 1.0 seconds; and a constant term. Left and right lane changes were used as two of the modes of behavior for both simulated and real traffic; they were defined as any 4.0-second window where the car center crossed a lane boundary at the midpoint of the window.

Simulated Traffic

The simulated traffic includes three lanes of traffic, with cars entering the field of view stochastically. Each car has a default velocity that it will maintain unless there is a car in the way. In that case, if there is room in an adjacent lane, the car will change lanes; otherwise, it will slow down. Gaussian noise is added to the observations of the cars' positions to emulate the inherent noise in physical sensors.

In addition to left and right lane change modes, several possible sets of modes were experimented with for the traffic data, including modes defined in terms of y velocity, headway, and a combination of y velocity and headway. The results presented herein use left and right lane change modes and two different “stay-in-lane” modes for cars at different speeds (i.e., fast and slow).

The accuracy of the learned MMPSR are compared with two other prediction methods: a baseline method that predicts that the car will maintain its last observed velocity, and locally weighted linear regression trained upon the entire data set. The models' predictions were evaluated about how far each car would travel in the y direction over the future 2 and 5 seconds.

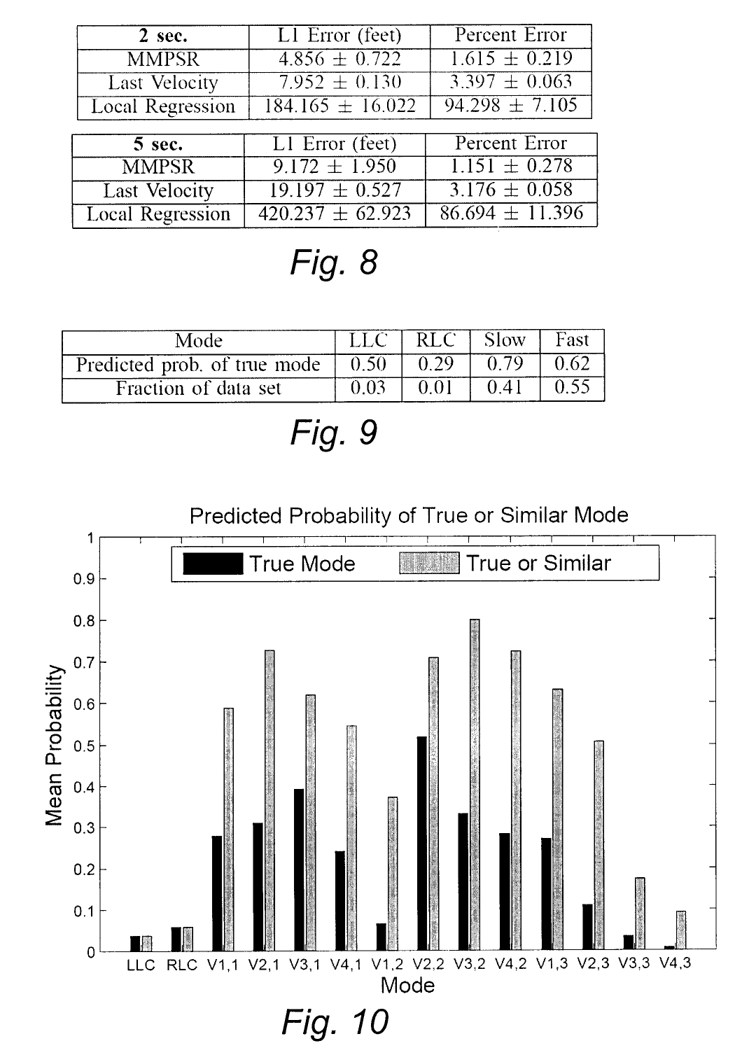

The MMPSR performed significantly better than both comparison methods at both the 2 and 5-second horizons. See FIG. 8, which shows error in predicting distance traveled for simulated traffic. The MMPSR achieves the lowest error for predicting both 2 and 5 seconds in the future. The confidence intervals are two standard deviations, computed across 15 data sets. Even in the presence of noisy observations, the MMPSR achieves less than 2% error (relative to distance traveled), for both 2 and 5 seconds in the future. Not only does the MMPSR predict the movement of the cars accurately, it also assigns reasonably high likelihood to the true value of the current mode. See FIG. 9, which shows predicting the current mode for simulated traffic. “LLC” and “RLC” are left and right lane changes. The low likelihoods for the “lane change” modes are primarily due to the low prior probability of those modes.

Interstate 80 Traffic

An MMPSR was learned to model real highway traffic on interstate 80 (I-80) near San Francisco. Data collected by the Next Generation SIMulation (NGSIM) project was used. NGSIM used cameras to capture traffic movement along approximately 500 meters of a six-lane freeway.

As with the simulated traffic, several sets of mode definitions were experimented with. The results presented herein use modes determined by the y velocity and the headway to the car in front, which were discretized into four and three bins, respectively. Along with the two lane change modes, which gives fourteen total modes for the system. Partly because of the fine distinctions between the modes (cf. the simulated traffic with only two velocity bins), the MMPSR has more difficulty determining the true mode than with the previous domains.

FIG. 10 shows predicting the current mode for I-80 traffic: likelihood assigned to the true (or similar) modes by the learned MMPSR. Regarding the mode labels, LLC and RLC are left and right lane changes; the other labels “V k, j” indicate the mode of a car that falls in the k^{th} velocity bin (4 is fastest) and j^{th} headway bin (3 is the longest distance to the car in front). However, the likelihood that the MMPSR assigns to either the true mode or a similar mode (i.e., those that differ by one notch in velocity or headway, but not both) is significantly higher.

Even though the MMPSR does not always track the true mode, its predicted modes are close enough to enable good predictions about the cars' movements. These predictions were evaluated in the same way as for the simulated traffic, including a comparison with locally-weighted regression and predicting the last velocity. An MMPSR was also evaluated which uses an “oracle” feature that peers into the future. This feature is included in the low-level state, even though it will never be available online. Nevertheless, the oracle MMPSR's error provides a sense of the best error that could be achieved.

Specifically, the oracle feature is the desired prediction (i.e., the distance the car will travel) minus the future value of the gap between it and the car it is following. This evaluation only considers the time points where there is a car in front of the modeled car; otherwise, the oracle feature is not defined. In the I-80 data set, there is almost always a car in front, so the vast majority of the data is evaluated.

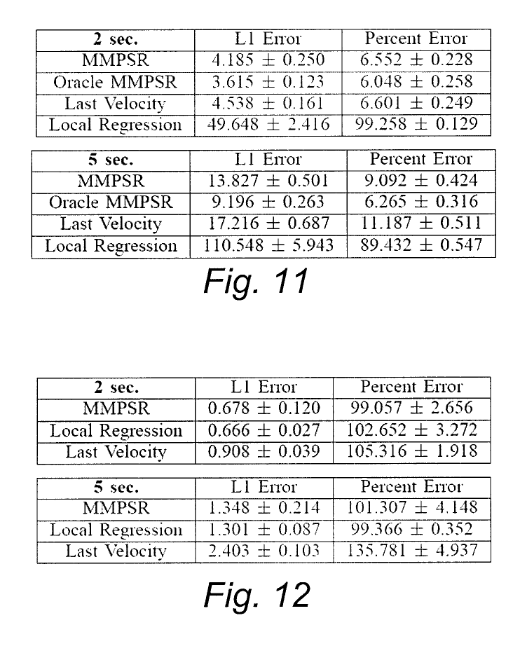

As with the simulated traffic, the MMPSR performed better than both the local-regression and the last-velocity comparison methods at both the 2 and 5-second horizons, with a considerable difference at the 5-second horizon. FIG. 11 shows error in predicting distance traveled for I-80 traffic. The “Oracle MMPSR” error provides a sense of the best error that could be achieved. Among the remaining models, the MMPSR achieves the lowest error for predicting both 2 and 5 seconds in the future. The confidence intervals are two standard deviations, computed across 15 data sets. Also, the error of the MMPSR is reasonably close to that of the oracle MMPSR, despite all the information contained in the oracle feature. The MMPSR achieves less than ten percent error (relative to distance traveled), even when predicting five seconds in the future for cars at highway speeds. In absolute terms, this is about 14 feet, or roughly one car length.

FIG. 12 shows the error in predicting lateral movement for the MMPSR, the last-velocity model, and locally-weighted linear regression. In FIG. 12, the last-velocity comparison model has the highest error, while the MMPSR and local regression models are comparable. The confidence intervals in the tables are two standard deviations, computed across 15 data sets. The percent error is so high because the true lateral movement is sometimes small, so even small absolute errors can translate to large percent errors.

The oracle MMPSR is not applicable to lateral movement. The last-velocity model does the worst, while the MMPSR and local regression models are comparable. The percent error is so high because the true lateral movement is sometimes very small. For those time points, a small absolute error results in an enormous percent error, which skews the average percent error. However, in absolute terms, the average error of the MMPSR is quite small: less than 1.5 feet for five seconds in the future.

Neither the last-velocity model nor local regression performed well on both lateral and forward predictions. This is in contrast to the MMPSR, which is comparable to (or better than) the better of the comparison methods for both lateral and forward predictions.

Above, the MMPSR, a hierarchical model motivated by the problem of modeling vehicles' movements, is introduced. In general, MMPSRs can model uncontrolled systems that switch between modes of behavior. Inspired by PSRs, the modes are not latent variables but are defined in terms of both historical and future observations. Because the modes are defined in terms of observations, learning the MMPSR model is more efficient than if the modes were latent variables. Furthermore, when using the MMPSR model to make predictions, the MMPSR can adjust its state to reflect the true values of the modes because those true values are eventually recognized from the observations.

Even though the modes are defined in terms of observations, they are not restricted to be features of history, which would limit the expressiveness of the model. Rather, the mode definitions can include future observations, allowing modes such as a right lane change. Introduced above is a learning algorithm for the MMPSR, using it to learn MMPSR models of three systems, including simulated and real-world highway traffic. The MMPSR achieved lower error than comparison methods on all three systems, including the highway traffic on I-80.

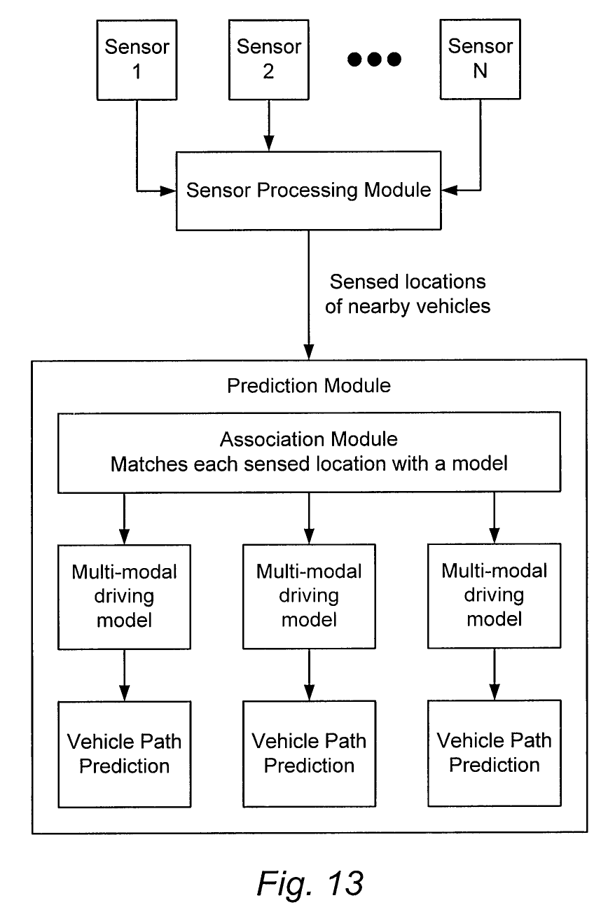

FIG. 13 is a functional block diagram of a vehicle path prediction system. A plurality of sensors (Sensor 1, Sensor 2 . . . Sensor N) send sensor data to a sensor processing module. Exemplary sensors include LIDAR (Light Detection And Ranging), radar, sonar, other time-of-flight based sensors, and cameras (including stereoscopic cameras). This disclosure should not be interpreted as restricted to any particular type of sensor. The sensor processing module outputs processed data to a prediction module and can implement object-detection processes to identify vehicles or other objects from the sensor data. Although not particularly limiting to any method of object detection, exemplary aspects include object detection algorithms based on a type of sensor used. For example, a video or image-based object detection algorithm may be used when the sensor is a camera. Also, an edge-detection and comparison-based algorithm may be used when the sensor includes LIDAR. In the prediction module, an association module matches each sensed location of a vehicle with a model, which is then used to perform vehicle path prediction.

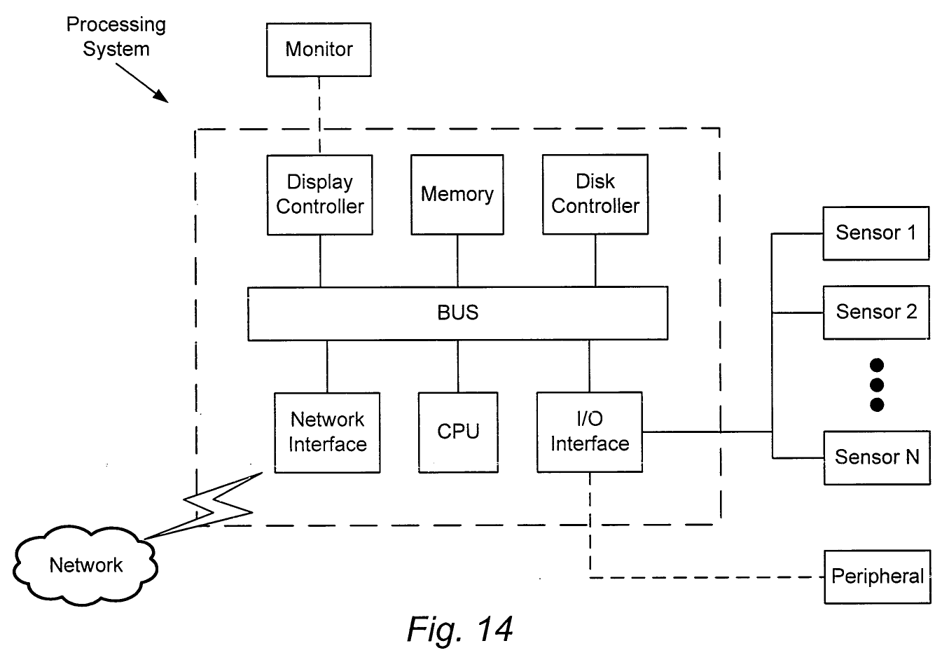

FIG. 14 is a hardware diagram of a processing system embodying the vehicle path prediction system shown in FIG. 13. The processes, algorithms and electronically driven systems described herein can be implemented via a discrete control device provided in the vehicle, or can be implemented by a central processing device of the vehicle, such as an electronic control unit (ECU). Such a system is described herein as a processing system.

As shown in FIG. 14, a processing system in accordance with this disclosure can be implemented using a microprocessor or its equivalent, such as a central processing unit (CPU) or at least one application specific processor ASP (not shown). The microprocessor utilizes a computer readable storage medium, such as a memory (e.g., ROM, EPROM, EEPROM, flash memory, static memory, DRAM, SDRAM, and their equivalents), configured to control the microprocessor to perform and/or control the processes and systems of this disclosure. Other storage mediums can be controlled via a controller, such as a disk controller, which can controls a hard disk drive or optical disk drive.

The microprocessor or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The microprocessor can be a separate device or a single processing mechanism. Further, this disclosure can benefit form parallel processing capabilities of a multi-cored CPU.

In another aspect, results of processing in accordance with this disclosure can be displayed via a display controller to a monitor. The display controller would then preferably include at least one graphic processing unit for improved computational efficiency. Additionally, an I/O (input/output) interface is provided for inputting sensor data from Sensors 1, 2 . . . N.

Further, as to other input devices, the same can be connected to the I/O interface as a peripheral. For example, a keyboard or a pointing device (not shown) for controlling parameters of the various processes and algorithms of this disclosure can be connected to the I/O interface to provide additional functionality and configuration options, or control display characteristics. Moreover, the monitor can be provided with a touch-sensitive interface to a command/instruction interface.

The above-noted components can be coupled to a network, as shown in FIG. 14, such as the Internet or a local intranet, via a network interface for the transmission or reception of data, including controllable parameters. The network can also be a vehicle-centric network such as a vehicle local area network. In such an implementation, vehicle path prediction can be routed by packets to automated vehicle equipment to control steering and braking for purposes of collision avoidance via the vehicle local area network. Other implementations include safety warnings and driver assistance. A central BUS is provided to connect the above hardware components together and provides at least one path for digital communication there between.

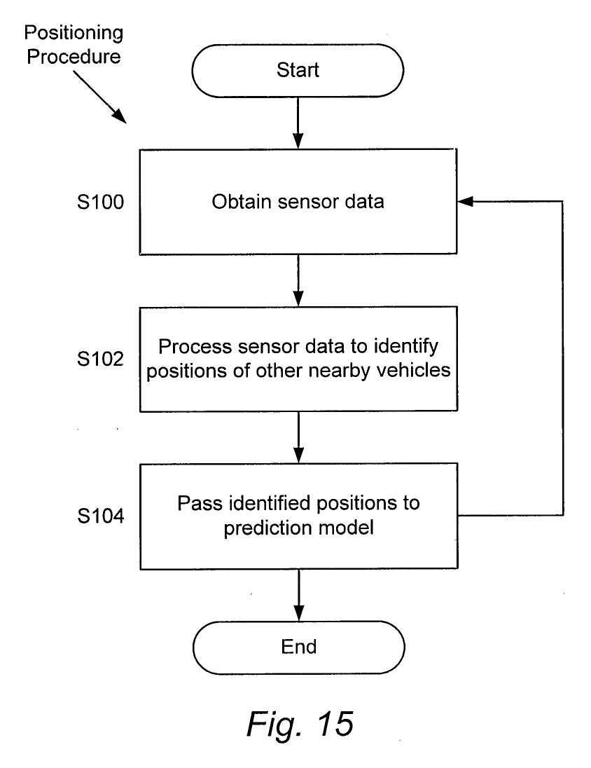

FIG. 15 is an algorithmic flowchart illustrating a positioning procedure of the vehicle path prediction system shown in FIG. 13. At S100, sensor data is obtained by a processing system from various sensors. The sensor data is processed at S102 to identify positions of other nearby vehicles. The identified positions of the other nearby vehicles are passed to a prediction model at S104. The identified positions include location data, such as coordinate locations relative to the driven vehicle, and orientation data. As such, sequential identified positions of a vehicle describe the vehicles path and progression.

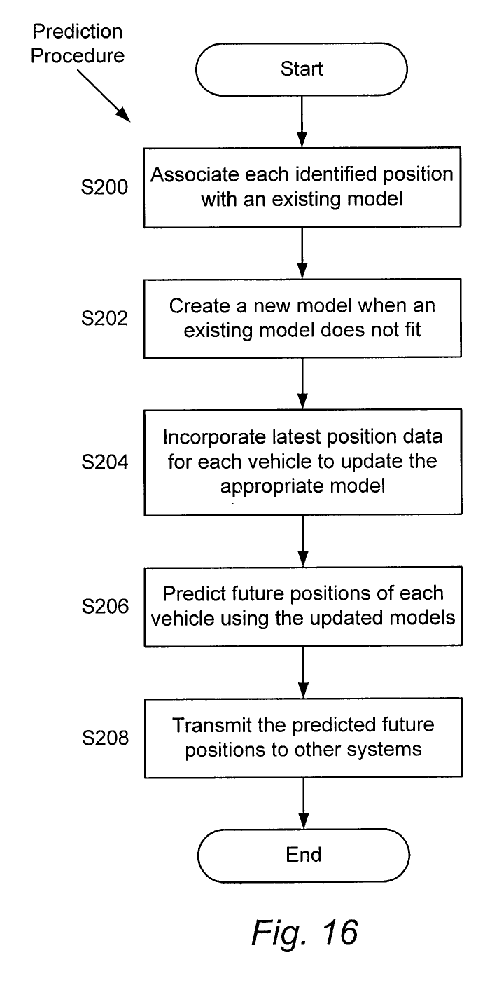

FIG. 16 is an algorithmic flowchart illustrating a prediction procedure of the vehicle path prediction system shown in FIG. 13. At S200, each identified (sensed) position of the subject vehicle is associated with an existing model. Should no model currently exist (that is, no model fits the identified position of the subject vehicle), a new model is created at S202 and associated with the subject vehicle's identified position.

At S204, the latest location data for the subject vehicle is incorporated to update the subject vehicle's associated model. Then, at S206, future positions for the subject vehicle are predicted using the updated model. Similar processes are performed (either sequentially or in parallel) for positions of other sensed vehicles. After the future positions have been predicted, these predicted future positions are transmitted to other vehicle systems, including safety systems, collision avoidance systems, driver-alert (warning) systems, and autonomous driving systems. In particular, such systems can provide blind-spot warnings based on the predicted future positions, as well as front and rear proximity warnings based on the predicted future positions.

Any processes, descriptions or blocks in flow charts or functional block diagrams should be understood as representing modules, segments, portions of code which include one or more executable instructions for implementing specific logical functions or steps in the processes/algorithms described herein, and alternate implementations are included within the scope of the exemplary embodiments of this disclosure in which functions may be executed out of order from that shown or discussed, including substantially concurrently or in reverse order, depending upon the functionality involved.

Moreover, as will be recognized by a person skilled in the art with access to the teachings of this disclosure, several combinations and modifications of the aspects of this disclosure can be envisaged without leaving the scope of this disclosure. Thus, numerous modifications and variations of this disclosure are possible in light of the above teachings, and it is therefore to be understood that within the scope of the appended claims, this disclosure may be practiced otherwise than as specifically described herein.

1. A processing system of a driven vehicle, comprising:
a receiver configured to receive position data of a subject vehicle which is nearby the driven vehicle;
an association module configured to associate the position data of the subject vehicle with a driving model;
an update module configured to update the driving model by incorporating latest position data of the subject vehicle received by the receiver; and
a prediction module configured to predict a future position of the subject vehicle using the updated driving model.

2. The processing system according to claim 1, further comprising:
a transmitter configured to transmit the predicted future position of the subject vehicle to an other processing system of the driven vehicle.

3. The processing system according to claim 2, wherein the other processing system is a collision avoidance or warning system, which provides a driver notification based on the predicted future position.

4. The processing system according to claim 2, wherein the other processing system is an autonomous driving system, which provides vehicle actuation based on the predicted future position.

5. The processing system according to claim 1, wherein the association module includes circuitry to determine whether the position data of the subject vehicle fits a currently stored and available driving model, and is configured to generate a new driving model for association with the position data of the subject vehicle when no currently available or stored driving model fits the position data of the subject vehicle.

6. The processing system according to claim 5, wherein the new driving model is a multi-mode predictive state representation (MMPSR) which is configured to marginalize unknown modes of history.

7. The processing system according to claim 6, wherein the MMPSR is generated, by the association module, from learning high and low-level component models from a single sequence of observations, and is updated, by the update module, in time-steps to reflect new history of the subject vehicle.

8. The processing system according to claim 1, wherein:
the receiver is configured to receive position data for a plurality of subject vehicles nearby the driven vehicle;
the association module is configured to associate the position data of each of the subject vehicles with one respective driving model;
the update module is configured to update each respective driving model by incorporating latest position data of the respective subject vehicle received by the receiver; and
the prediction module is configured to predict future positions of the subject vehicles using the respective updated driving models.

9. The processing system according to claim 8, wherein the association module includes circuitry to determine whether each position data of each subject vehicle fits a currently stored and available driving model, and is configured to generate new driving models for association with each position data when no currently available or stored driving model fits the position data.

10. The processing system according to claim 1, wherein the position data describes locations and orientations of the subject vehicle, and is obtained through a plurality of sensors of the driven vehicle.

11. The processing system according to claim 1, further comprising:
a central processing unit configured to execute instructions, memory configured to store data, including the position data, and an input/output interface configured to connect to sensor of the driven vehicle.

12. A processing system of a driven vehicle, comprising:
means for receiving position data of a subject vehicle which is nearby the driven vehicle;
means for associating the position data of the subject vehicle with a driving model;
means for updating the driving model by incorporating latest position data of the subject vehicle received by the means for receiving; and
means for predicting a future position of the subject vehicle using the updated driving model.

13. A method for a driven vehicle, comprising:
receiving position data of a subject vehicle which is nearby the driven vehicle;
associating the position data of the subject vehicle with a driving model;
updating the driving model by incorporating latest position data of the subject vehicle received in the receiving; and
predicting a future position of the subject vehicle using the updated driving model.

14. A computer-readable storage medium having stored therein computer-executable instructions, which when executed by a computer, causes the computer to perform the method according to claim 13.
